(19) United States
(12) Patent Application Publication
(10) Pub. No.: US 2004/0112963 A1
(43) Pub. Date: Jun. 17, 2004

(54) Bar code scanner

(75) Inventor: Denis M. Blanford, Duluth, GA (US)

Correspondence Address: PAUL W. MARTIN, LAW DEPARTMENT, WHQ-4, 1700 S. PATTERSON BLVD., DAYTON, OH, 45479-0001, US

(73) Assignee: NCR Corporation

(21) Appl. No.: 10/320,596

(22) Filed: Dec. 16, 2002

(51) Int. Cl. G06K 7/10; G06K 9/22; G06K 19/06; G02B 26/10

(52) U.S. Cl. 235/462.25

(57) ABSTRACT

A scanner is disclosed for scanning a bar code having a plurality of alternating bars and spaces of varying widths. The scanner comprises means for scanning a bar code sequentially across said bars and spaces for providing a bar code signature. The scanner comprises means for determining whether or not a readable bar code has been read correctly. The scanner is further arranged to operate in a first mode at a first scan speed when the bar code being scanned can be read and in a second mode at a second scan speed, when said bar code can not be read, said second scan speed being lower than said first scan speed.

The present invention relates generally to bar code scanners and, more specifically, to scanning bar codes that are overprinted or underprinted or bar codes of different magnifications.

### BACKGROUND OF THE INVENTION

Conventional bar codes have varying width bars and spaces suitably printed on a label. The bar code may take any conventional form in one or more dimensions, and includes, for example, the typical one-dimensional UPC form. The UPC symbology is based on a specification enacted by the Uniform Product Code Council, Inc. of Dayton Ohio. The typical UPC bar code includes a series or sequence of alternating dark bars and light spaces of varying widths. The bars and spaces are arranged in groups representing individual characters. The bar code starts with a left margin character and ends with a right margin character, and has a center reference character as well, with the characters provided there between representing any desired data.

The minimum width of either a bar or space in the UPC symbology is defined as a single module, which represents a unit width. The width of a single character coded using the UPC symbology is seven (7) modules. A seven module UPC character has two bar and two space elements which have varying widths to differentiate between the respective characters.

A conventional bar code scanner, such as a laser scanner, sweeps a scan beam across the bar code over all the bars and spaces, and light back scattered therefrom is detected by a photodetector in the scanner which provides a signature therefor of alternating maximum and minimum signal intensity and varying time duration. The maximum signal intensity corresponds with detection of the white space, and the minimum signal intensity corresponds with detection of the dark bar. Since the sweeping speed of the scan beam is precisely known, the relative time duration of the alternating minimum and maximum signal intensities corresponds with the varying widths of the bars and spaces. The scanner includes a conventional decoder, which recognizes the varying widths of the detected bars and spaces based on the width modules and provides the corresponding data characters encoded thereby.

Accordingly, the accurate sizing of the relative width of the bars and spaces is critical to properly decoding the data encoded thereby. If a bar or a space is either too wide or too narrow, the decoder will fail to recognize the bar code as being valid, and therefore the bar code cannot be read.

Most omnidirectional bar code scanners used in supermarkets use very high-speed pattern generating motor assemblies to project a laser beam across a bar code to detect the widths of the dark and light of the bar code. A high scan speed is required to generate enough laser scan lines to perform the omnidirectional scan function. However, when a bar code is highly demagnified (very small) or highly over printed or under printed the widths of some of the white or black areas in the bar code become so small that they can not be detected and properly measured by the scanning system.

One solution to this problem would be to utilize increasingly higher speed electronics to undertake the data acquisition function in the scanner. However, this solution is prohibitively expensive, especially in the low margin field of commercial bar code scanner manufacture.

It is an object of the present invention to produce a bar code scanner, which obviates the problems discussed above.

It is a further object of the present invention to produce a bar code scanner, which can scan demagnified and over or under printed bar codes.

### SUMMARY OF THE INVENTION

According to a first aspect of the present invention there is provided a scanner for scanning a bar code having a plurality of alternating bars and spaces of varying widths, the scanner comprising means for scanning said bar code sequentially across said bars and spaces for providing a bar code signature, means for determining whether or not a readable bar code has been detected, said scanner being arranged to operate in a first mode at a first scan speed when the bar code being scanned can be read and in a second mode at a second scan speed, when said bar code can not be read, said second scan speed being lower than said first scan speed.

According to a second aspect of the present invention there is provided a scanner for scanning a bar code having a plurality of alternating bars and spaces of varying widths, the scanner comprising means for scanning said bar code sequentially across said bars and spaces for providing a bar code signature, means for determining whether or not a readable bar code has been detected and means for reducing the speed of scanning in the event that the scanner has not detected a recognizable bar code.

According to a third aspect of the present invention there is provided a method of scanning a bar code having a plurality of alternating bars and spaces of varying widths, the method comprising the steps of a) scanning said bar code sequentially across said bars and spaces for providing a bar code signature, b) determining whether or not a readable bar code has been detected and c) operating the scanner in a first mode at a first scan speed when the bar code being scanned can be read and in a second mode at a second scan speed, when said bar code can not be read, said second scan speed being lower than said first scan speed.

According to a fourth aspect of the present invention there is provided a method of scanning bar codes using a bar code scanner, the bar codes having a plurality of alternating bars and spaces of varying widths, and the method comprising the steps of a) scanning said bar code sequentially across said bars and spaces for providing a bar code signature, b) determining whether or not a readable bar code has been detected and c)reducing the speed of scanning in the event that the scanner has not detected a recognizable bar code.

An advantage of the reduction in scanning speed, as described above, is the resultant perceived increase in detected bar and spacing width, which in turn allows for easier scanning without the need for fast data processing electronics.

### DESCRIPTION OF THE DRAWINGS

The invention, in accordance with preferred and exemplary embodiments, together with further objects and advantages thereof, is more particularly described in the following detailed description taken in conjunction with the accompanying drawing which is a schematic representation of a bar code scanner in accordance with the present invention.

### DESCRIPTION OF THE PREFERRED EMBODIMENT

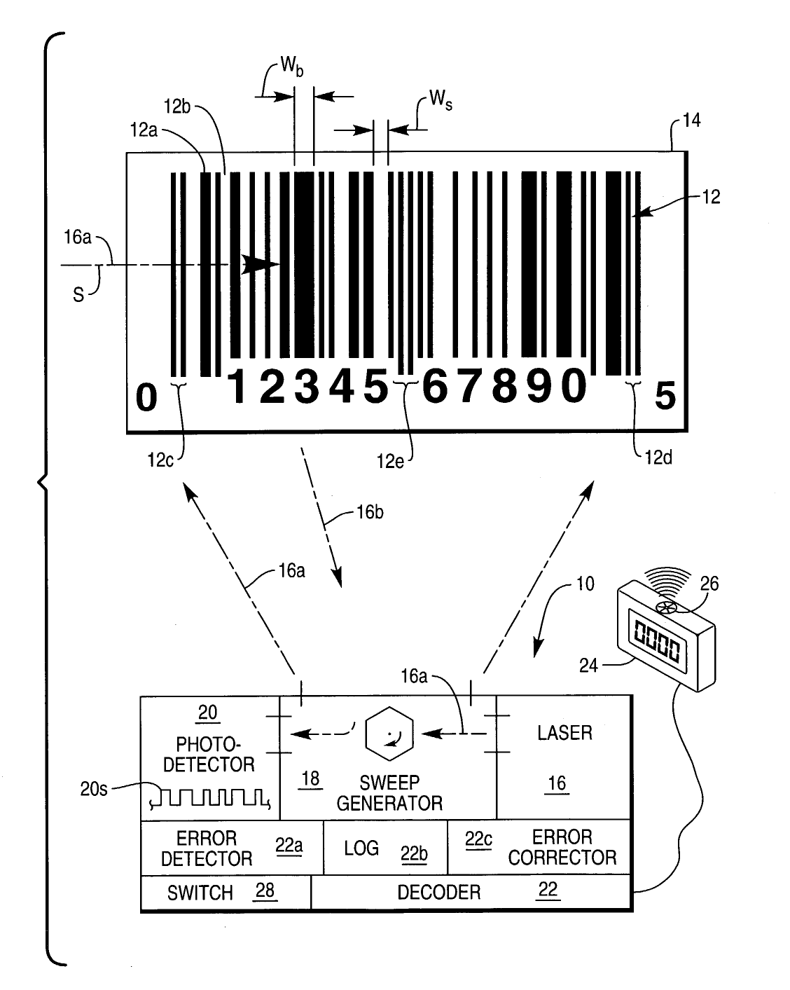

Illustrated schematically in FIG. 1 is a laser bar code scanner 10 for scanning and decoding a conventional bar code 12 printed on a suitable label 14. The bar code 12 may take any conventional form in one or more dimensions including the conventional one-dimensional UPC symbology illustrated. The exemplary bar code 12 illustrated in FIG. 1 includes a plurality of sequential or alternating dark bars 12a and white spaces 12b, which are straight and parallel to each other and have corresponding varying widths W.sub.b and W.sub.s. The bars and spaces are arranged in a plurality of sequential groups defining respective characters of equal width. The minimum width of a bar or a space is defined as the minimum width module, and in the UPC symbology must equal or exceed 8 mils by specification. A single UPC character is defined as having two bars 12a and two spaces 12b of varying widths. And, the specified widths of a single character coded using the UPC symbology must, by specification, be seven modules. Furthermore, the UPC symbology defines the maximum bar width as being four modules.

In the exemplary bar code 12 illustrated in FIG. 1, the bar code conventionally starts with a left margin character 12c, ends with a right margin character 12d, and has a center reference character 12d, with the remaining bars and spaces there between defining desired data characters. As indicated above, each of the data characters has a total width of seven modules and includes two bars and two spaces.

The exemplary scanner 10 illustrated in FIG. 1 includes conventional means for optically scanning the bar code 12 sequentially across the bars and spaces 12a,b over the total width of the bar code 12 from the left margin character 12c to the right margin character 12d. In the preferred embodiment illustrated, scanning is accomplished by using a conventional laser 16 which emits a suitable laser beam 16a which is suitably scanned across the face of the bar code 12 by a conventional sweep generator 18 which may take the form of a rotating multifaceted mirror. The laser beam 16a is scanned transversely across the bar code 12 in a scan direction S so that back scattered light 16b reflects off the bars and spaces back to the scanner. Since the bars 12a are dark, very little light is back scattered therefrom, whereas the spaces 12b are substantially white and more effectively back scatter light to the scanner.

A conventional photo-detector 20 is provided in the scanner 10 and is suitably optically aligned therein for receiving the back scattered light 16b and producing an electrical bar code signature 20s alternating in intensity between maximum and minimum values corresponding with the back scattered light 16b from the spaces 12b and bars 12a, respectively. The time duration of the maximum and minimum intensity portions of the signature 20s corresponds with the varying widths of the bars and spaces. Since the scan beam 16a is scanned across the bar code 12 at a known and constant rate of speed, the bar code signature 20s is representative of the bar code 12 itself and may be decoded in a conventional decoder 22 specifically configured for the corresponding bar code symbology printed on the label 14.

The decoder 22 may take any conventional form and is typically a digitally programmable microprocessor containing suitable software for analyzing the bar code signature 20s and decoding the data contained therein. The scanner 10 is electrically joined to a suitable display 24 which may be used for displaying certain information encoded in the bar code 12, such as the price of a consumer product represented thereby. When the bar code 12 is accurately scanned and decoded, the data may be presented on the display 24, and a small speaker 26 operatively joined to the scanner 10 may beep to indicate successful decoding of the bar code 12.

However, if the scanner 10 is unable to decode the bar code 12, the speaker 26 will not beep and the display 24 will remain blank. Multiple passes of the bar code 12 over the scanner 10 may be attempted in order to properly read the label if possible, or if the bar code 12 is defective it cannot be read.

Over printing or under printing or demagnifying of a bar code 12 will result in either the bars or spaces, or both, being too small to be read by conventional bar code scanners. In that case the scanner 10, in accordance with the present invention, may be utilized to read the bar code. This is achieved by the sweep generator 18 in the scanner 10 being arranged to operate at two or more different scan speeds.

In one embodiment, the scanner 10 attempts to read a bar code 12 in a first mode, at a first speed. If this is unsuccessful the scanner 10 diverts to a second mode, at a second, and lower, speed. In another embodiment the scanner 10 can be switched between said first and second modes manually. This is achieved by using a switch 28, by scanning a predetermined bar code, or by any other means of communication to the scanner which would be known to a person skilled in the art, the detection of which instructs the scanner 10 to switch mode.

In yet another embodiment, in said second mode the scan speed is reduced sequentially and the bar code 12 is scanned at each reduced scan speed, until the bar code 12 can be read. In this way the bar code 12 is scanned at approximately the highest scan speed possible.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What we claim is:

1. A scanner for scanning a bar code having a plurality of alternating bars and spaces of varying widths, the scanner comprising:
means for scanning said bar code sequentially across said bars and spaces for providing a bar code signature;
means for determining whether or not a readable bar code has been detected
said scanner being arranged to operate in a first mode at a first scan speed when the bar code being scanned can be read and in a second mode at a second scan speed, when said bar code can not be read, said second scan speed being lower than said first scan speed.

2. The scanner of claim 1, further comprising automatic means for entering said second mode when a bar code can not be read.

3. The scanner of claim 1, further comprising means for manually switching the scanner between the first and second scan modes, when a bar code can not be read.

4. The scanner of claim 3, when said means for switching the scanner between said first and second modes includes a switch on the scanner.

5. The scanner of claim 3, wherein said means for switching between said first and second modes includes a bar code which when scanned instructs the scanner to switch between said modes.

6. The scanner of claim 1, wherein the means for scanning said bar code comprises a pattern generating motor assembly arranged to scan bar codes at, at least, two different scan speeds.

7. The bar code scanner of claim 6, wherein said motor assembly is arranged to scan bar codes at a substantially continuous range of speeds.

8. A scanner for scanning a bar code having a plurality of alternating bars and spaces of varying widths, the scanner comprising:
means for scanning said bar code sequentially across said bars and spaces for providing a bar code signature;
means for determining whether or not a readable bar code has been detected and means for reducing the speed of scanning in the event that the scanner has not detected a recognizable bar code.

9. A method of scanning a bar code having a plurality of alternating bars and spaces of varying width, the method comprising the steps of:
a) scanning said bar code sequentially across said bars and spaces for providing a bar code signature;
b) determining whether or not a readable bar code has been detected; and
c) operating the scanner in a first mode at a first scan speed when the bar code being scanned can be read and in a second mode at a second scan speed, when said bar code can not be read, said second scan speed being lower than said first scan speed.

10 The method of claim 9, further comprising the step of automatically entering said second mode when a bar code can not be read.

11 The method of claim 9, further comprising the step of manually switching the scanner between the first and second scan modes, when a bar code can not be read.

12 The method of claim 11, wherein said manual switching of the scanner between said first and second mode utilizes a switch on the scanner.

13 The method of claim 12, wherein said manual switching of the scanner between said first and second modes is achieved by scanning a bar code arranged to instruct the scanner to change modes.

14 The method of claim 9, comprising the step of utilizing a pattern generating motor assembly arranged to scan bar codes at, at least, two different scan speeds.

15 The method of claim 14, wherein said motor assembly is arranged to scan bar codes at a substantially continuous range of speeds.

16 A method of scanning bar codes using a bar code scanner, the bar codes having a plurality of alternating bars and spaces of varying widths, and the method comprising the steps of:
a) scanning said bar code sequentially across said bars and spaces for providing a bar code signature;
b) determining whether or not a readable bar code has been detected and
c) reducing the speed of scanning in the event that the scanner has not detected a recognizable bar code.
